(19) United States
(12) Patent Application Publication
(10) Pub. No.: US 2012/0266090 A1
(43) Pub. Date: Oct. 18, 2012

(54) Browser Intermediary

(75) Inventors: Bryan W. Nealer, Seattle, WA (US); Li-Juan Qin, Bellevue, WA (US); Peter Chin, Bellevue, WA (US); Christopher A. Acker, Redmond, WA (US); Joseph D. Belfiore, III, Yarrow Point, WA (US)

(73) Assignee: Microsoft Corporation, Redmond, WA (US)

(21) Appl. No.: 13/089,155

(22) Filed: Apr. 18, 2011

(51) Int. Cl. G06F 3/048

(52) U.S. Cl. 715/760

(57) ABSTRACT

A browser intermediary provides a user interface that displays representations of various types of available web-based content. Selection of a particular web-based content from the browser intermediary causes a web browser application to be launched and the selected web-based content to be loaded in the browser user interface.

### BACKGROUND

Mobile devices with access to the Internet and the World Wide Web have become increasingly common, providing users with access to ever increasing amounts of data while on the go. Mobile device users frequently find themselves with small blocks of time during which they may want to quickly be able to access information. For example, while in a doctor's office waiting room, a user may choose to launch a web browser to pass the time. However, with the vast amount of data available over the web, it is likely that the user with a limited window of time will spend most of that time waiting for the browser or the web pages to load, and will not be able to quickly access information of interest.

### SUMMARY

This document describes a browser intermediary. Prior to launching an Internet browser application, the browser intermediary displays representations of various types of web content that a user is likely to find interesting. From the browser intermediary, the user can select a web page, a top story, a web page shared by friends through a social network, a really simply syndication (RSS) feed post, and so on. The browser application is then launched, and the selected content is automatically loaded into the browser application user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a pictorial diagram of an example environment in which a browser intermediary may be implemented.

FIG. 2 is a pictorial diagram of an example browser intermediary user interface displayed in response to a user-submitted request to execute a browser application.

FIG. 3 is a pictorial diagram illustrating launching of a browser application in response to a user-selection of a representation of a web page in an example browser intermediary user interface.

FIG. 4 is a pictorial diagram illustrating launching of a browser application in response to a user-selection of a representation of a top story in an example browser intermediary user interface.

FIG. 5 is a pictorial diagram illustrating launching of a browser application in response to a user-selection of a representation of real-time data in an example browser intermediary user interface.

FIG. 6 is a block diagram that illustrates components of an example mobile device configured to implement a browser intermediary.

FIG. 7 is a flow diagram of an example process for implementing a browser intermediary on a mobile device.

FIG. 8 is a flow diagram that illustrates an example process for presenting a user interface associated with a browser intermediary.

### DETAILED DESCRIPTION

A browser intermediary provides a landing scene between the launching point for a browser and the browser itself. The browser intermediary displays a snapshot of data that may include any combination of what's hot on the web, what's hot in a user's social graph, quick access to recently accessed web pages, quick access to open browser tabs, and quick access to user-defined favorites.

When a user enters a command to launch a browser application, rather than opening the browser and navigating to a pre-defined home page, the browser intermediary is launched. The browser intermediary is distinct from the browser application itself, but provides a user with the ability to launch the browser application to load any particular web page of interest from a plurality of displayed options.

For example, the browser intermediary may display a snapshot of data that includes favorite or recently accessed web pages. User selection of one of these favorite or recently accessed web pages results in the browser application being launched and the selected page being loaded in the browser. While favorite or recently accessed web pages may be known by the browser application, the snapshot of data displayed by the browser intermediary may also include other types of data that would not generally be known by a browser application. These may include, for example, top news stories, web content recently shared through a social network, recent Really Simple Syndication (RSS) feeds, etc., each of which may also have an associated web page. As such, user selection of one of these other types of data also results in the browser application being launched and the web page associated with the selected data being loaded in the browser.

By providing direct access to web pages associated with favorite or recently accessed web pages and other types of real-time information (e.g., top news stories, recent social networking updates, RSS feeds, etc.), the browser intermediary provides users with an interactive snapshot of the most popular web content at any given time, which enables a user with limited time to surf the web, an easy way to quickly identify and access web pages of interest.

### Example Environment

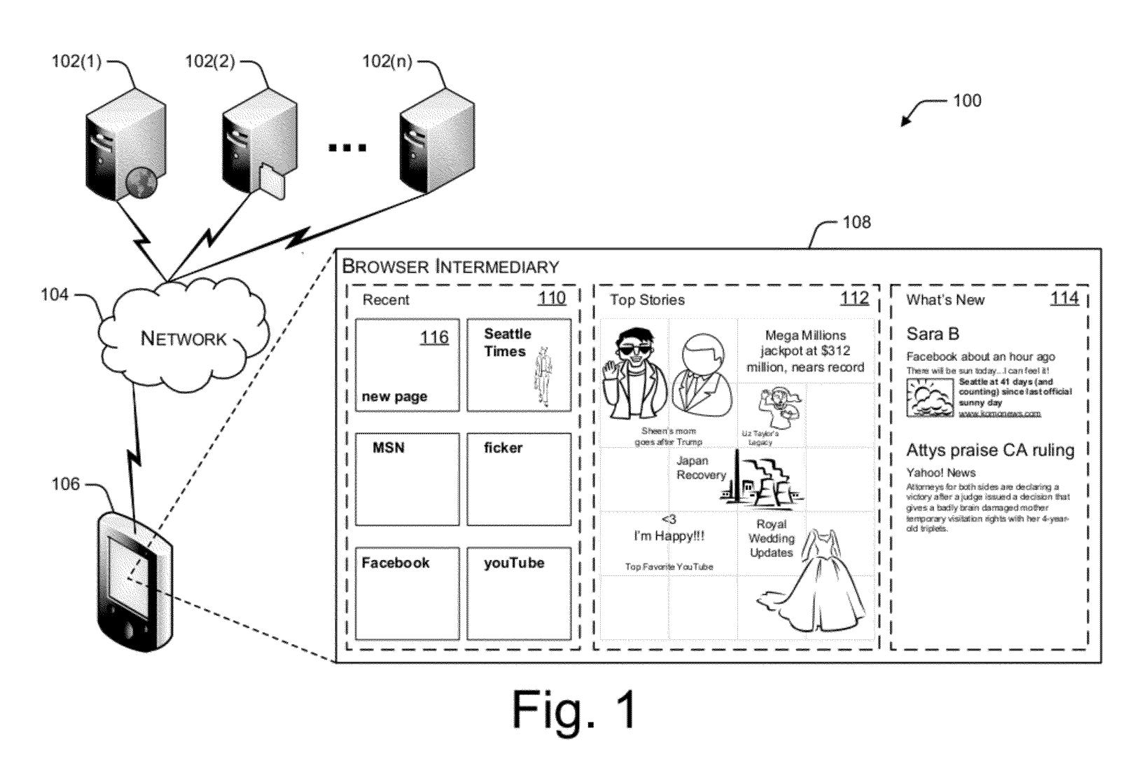

FIG. 1 illustrates an example environment 100 usable to implement a browser intermediary. Example environment 100 includes servers 102, network 104, and mobile device 106. Servers 102 may include, for example, web server 102(1), application server 102(2), and any number of other data servers 102(n). Network 104 is representative of any type of communication network including, for example, the Internet. Mobile device 106 is representative of any type of mobile device configured to receive data over network 104. For example, mobile device 106 may be implemented as a mobile phone, a personal digital assistant (PDA), a netbook, a tablet computer, a handheld computer, and so on.

When a user submits a command to launch a browser (e.g., Internet Explorer®), mobile device 106 presents a browser intermediary user interface 108 that displays a snapshot of data available through the selected browser application. In the illustrated example, user interface 108 includes a “Recent” section 110, a “Top Stories” section 112, and a “What's New” section 114.

“Recent” section 110 displays selectable representations of various web pages. These may include, for example, user-specified favorite web pages, web pages recently visited by the user, and/or pages most frequently visited by the user. As indicated by block 116, the “Recent” section 110 may also include a selectable representation for a “new page,” which, when selected, may launch a pre-defined home page associated with the browser or a pre-specified search engine web page. In an example implementation, one or more blocks in the “Recent” section 110 is a graphical image of the web page being represented.

“Top Stories” section 112 displays selectable representations of various currently popular web content. This may include, for example, top news stories, top entertainment stories, and top videos available through sites like YouTube.com. In the illustrated example, this section includes links to entertainment-related stories about Charlie Sheen and Elizabeth Taylor, a news story about Japan's recovery from a recent earthquake, a news story about the current lottery jackpot, a top YouTube video, and a website devoted to news surrounding an upcoming royal wedding in Great Britain. In an example implementation, as illustrated in FIG. 1, the size of each story representation may correspond to the popularity of that story across the World Wide Web. For example, in the illustrated example, the stories about Charlie Sheen and the royal wedding, each cover four squares of an underlying grid, while the stories about the lottery jackpot, the Japan recovery, and the YouTube video each cover two squares of the underlying grid, and the story about Elizabeth Taylor only covers a single square of the underlying grid. In this implementation, the relative sizes indicate relative popularity such that the stories about Charlie Sheen and the royal wedding are more popular than the story about the lottery, which is more popular than the story about Elizabeth Taylor. In an alternate implementation, each story may be represented by equal-sized representations. In another alternate implementation, the size of the representations may be based on other factors including, but not limited to, how recently the story was posted, such that, for example, larger representations indicate stories that were more recently posted to the web. Furthermore, in alternate implementations, rather than using the size of the representations to represent popularity or recentness of a post, the location of the representation may represent popularity and/or recentness of a post. For example, representations displayed nearer the top of the display may be more popular or more recent posts.

“What's New” section 114 displays selectable representations of other types of real-time data such as, for example, social network posts sharing web content and RSS feeds. In the illustrated example, this section includes one recent Facebook post and one recent post from a Yahoo! News RSS feed.

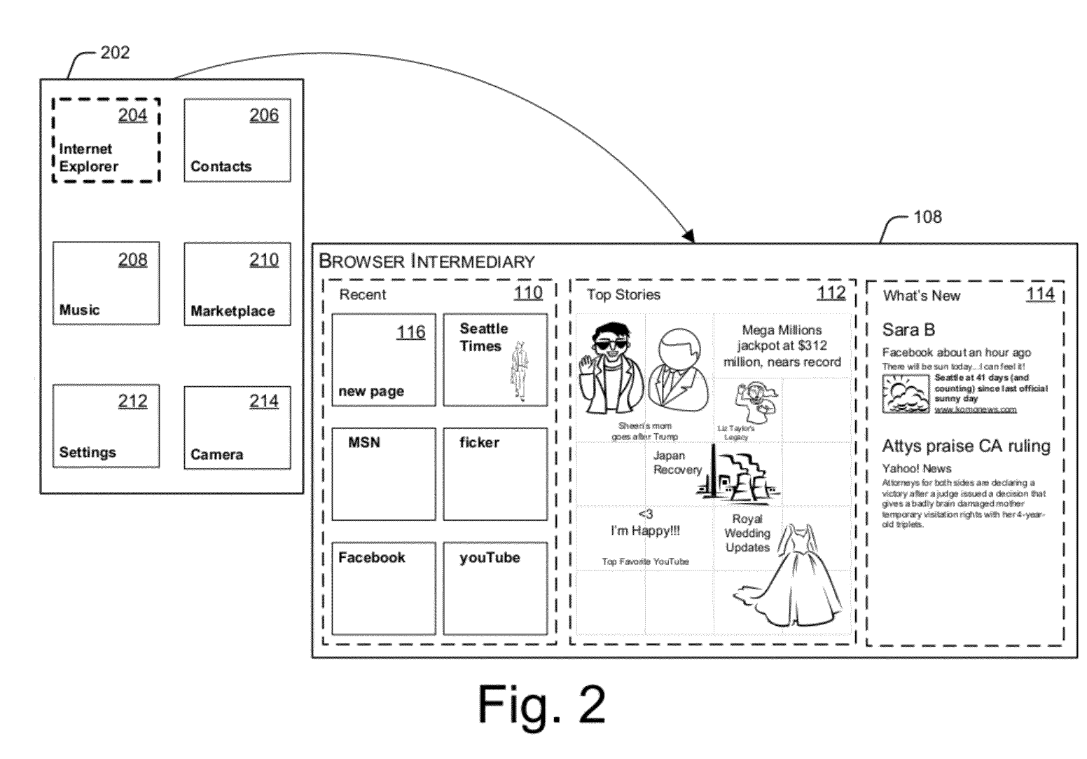

FIG. 2 illustrates an example transition from a first user interface 202 to previously described user interface 108. In the illustrated example, user interface 202 includes representations of multiple selectable items that may be available, for example, from a main page provided by the mobile device operating system. In the illustrated example, user interface 202 includes a browser application 204, access to a list of contacts 206, a music player 208, a marketplace 210 where additional applications can be purchased, access to device settings 212, and camera functionality 214. In the illustrated example, when a user selects the browser application (e.g., “Internet Explorer” 204), the user interface transitions to display the browser intermediary user interface 108.

In an alternate implementation (not illustrated), the browser intermediary may be directly represented on user interface, such as user interface 202. In such an implementation, a user may be able to directly select the browser intermediary, rather than accessing the browser intermediary as a result of selecting a browser application.

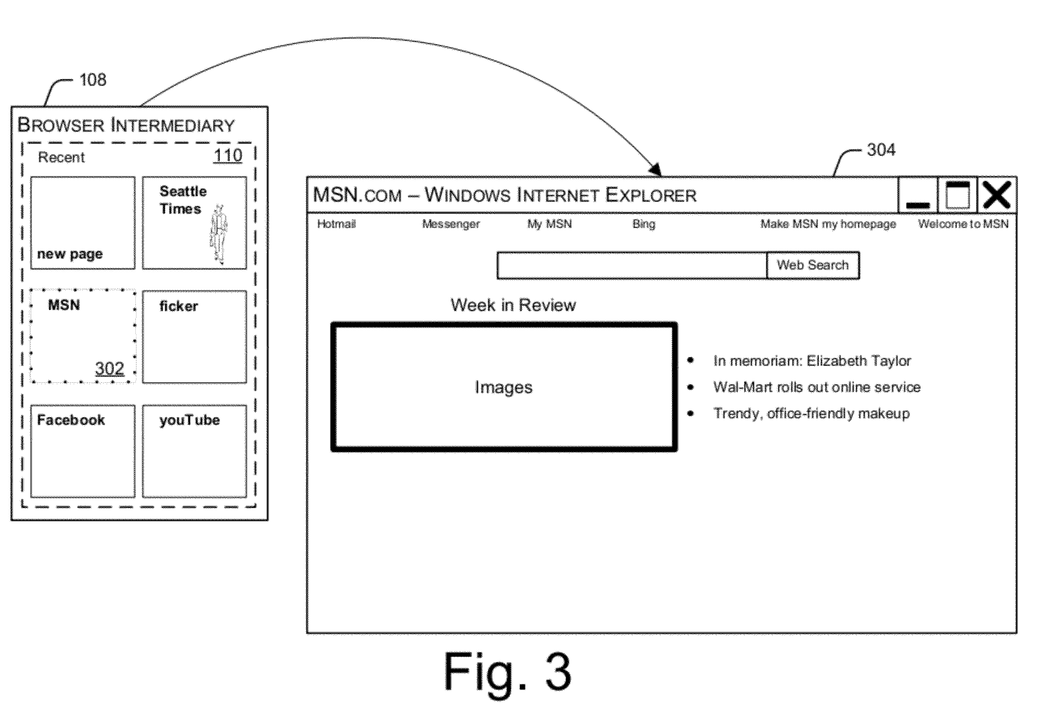

FIG. 3 illustrates an example transition from browser intermediary user interface 108 to a browser application based on user selection of a recent web page. In FIG. 3, the left-most portion of the browser intermediary user interface 108 is illustrated, showing the “Recent” section 110. When the user selects a representation of one of the recent web pages (e.g., MSN 302), the browser application is launched, and the browser user interface 304 is displayed with the selected web page (e.g., MSN.com) loaded in the browser.

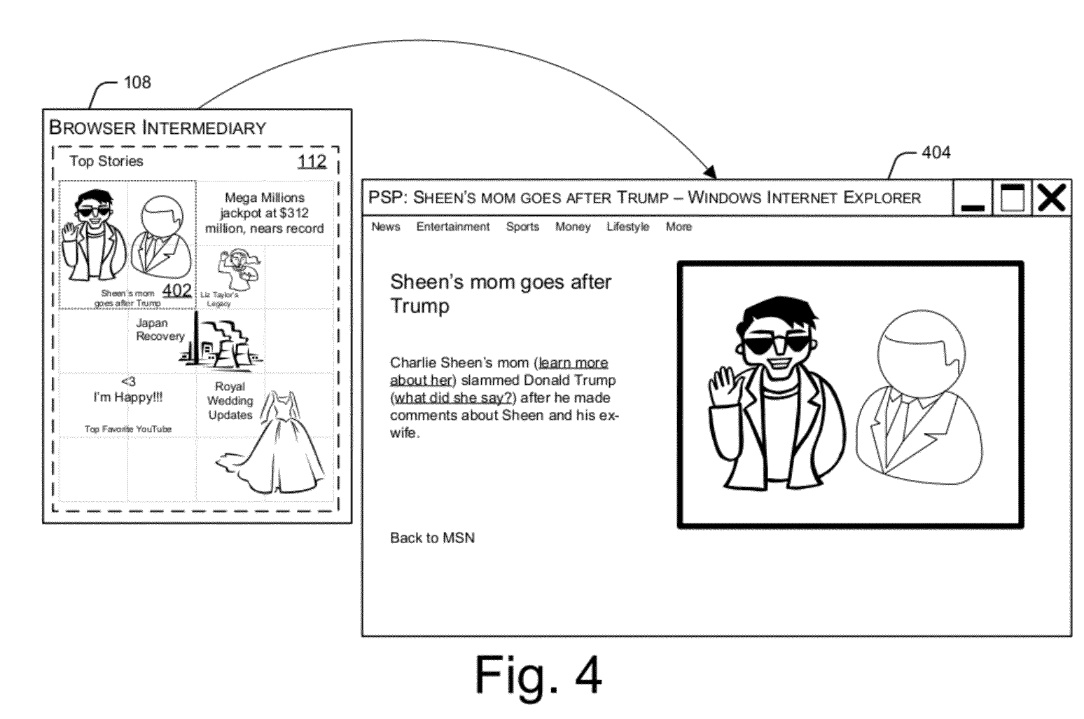

FIG. 4 illustrates an example transition from browser intermediary user interface 108 to a browser application based on user selection of a top story. In FIG. 4, the middle portion of the browser intermediary user interface 108 is illustrated, showing the “Top Stories” section 112. When the user selects a representation of one of the top stories (e.g., the story about Charlie Sheen 402), the browser application is launched, and the browser user interface 404 is displayed with the web page providing the selected story loaded in the browser. To facilitate loading the appropriate web page when the browser application is launched, each story representation in browser intermediary user interface 108 has an associated universal resource locator (URL) that is passed to the browser application when the browser application is launched.

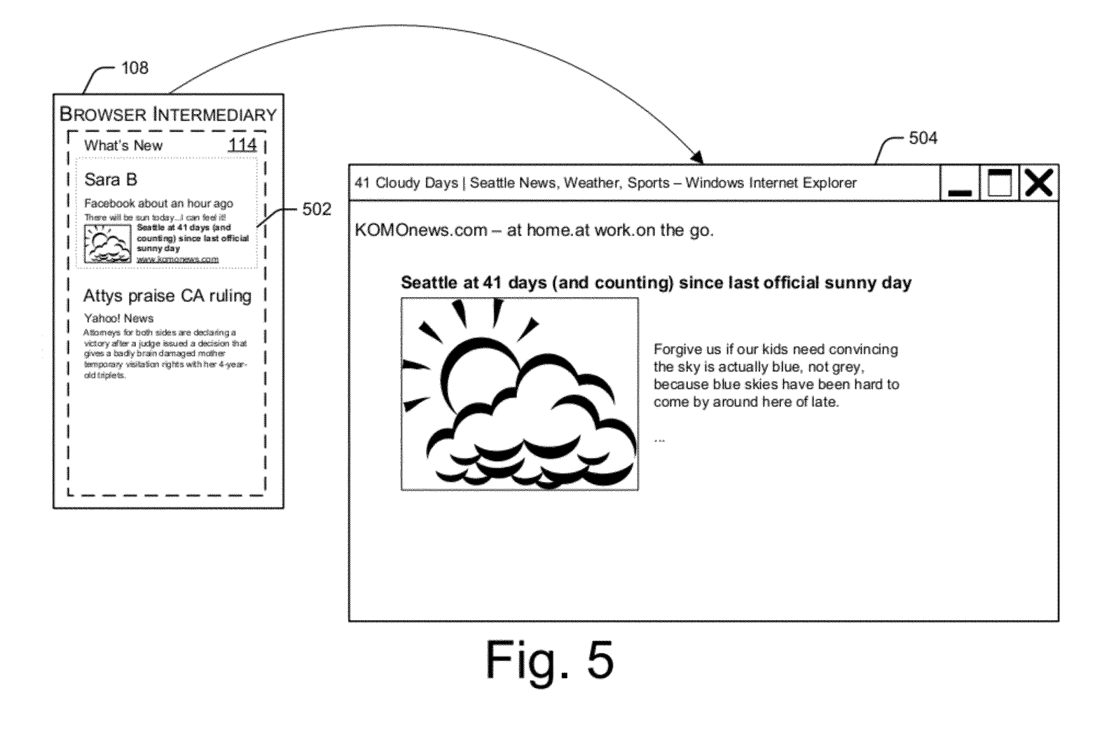

FIG. 5 illustrates an example transition from browser intermediary user interface 108 to a browser application based on user selection of real-time data. In FIG. 5, the right-most portion of the browser intermediary user interface 108 is illustrated, showing the “What's New” section 114. When the user selects one of the representations of real-time data (e.g., social network post 502), the browser application is launched, and the browser user interface 504 is displayed with the source of the selected data loaded in the browser. In the illustrated example, the selected item is a Facebook social networking post sharing a news story from a website. The browser is launched with the website hosting the shared news story. To facilitate loading the appropriate web page when the browser application is launched, each real-time data representation in browser intermediary user interface 108 has an associated universal resource locator (URL) that is passed to the browser application when the browser application is launched.

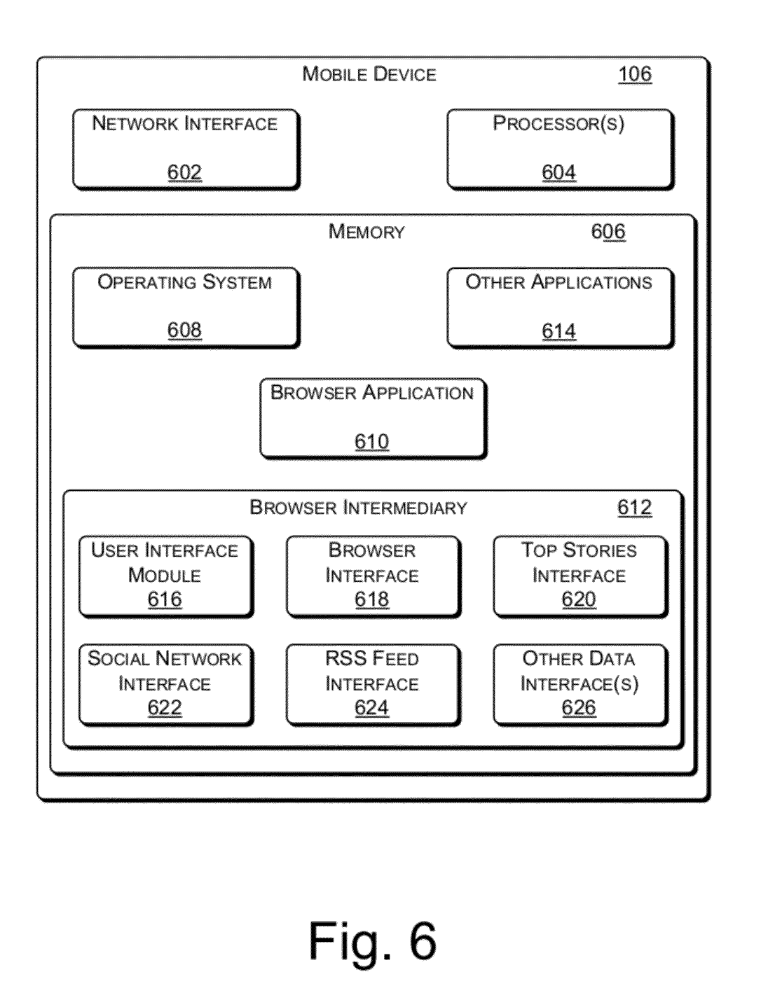

FIG. 6 illustrates components of an example mobile device 106 configured to support a browser intermediary as described herein. Example mobile device 106 includes a network interface 602, one or more processors 604, and a memory 606. Network interface 602 enables mobile device 106 to send and/or receive data over a network 104. Network interface 602 may also represent any combination of other communications interfaces to enable mobile device 106 to send and/or receive various types of communication, including, but not limited to, web-based data and cellular telephone network-based data.

An operating system 608, a browser application 610, a browser intermediary 612, and any number of other applications 614 are stored in memory 606 as computer-readable instructions, and are executed, at least in part, on processor 604. Browser intermediary 612 includes user interface module 616, browser interface 618, top stories interface 620, social network interface 622, RSS feed interface 624, and any number of other data interfaces 626 for making other types of data available through the browser intermediary user interface.

User interface module 616 correlates data from browser interface 618, top stories interface 620, social network interface 622, RSS feed interface 524, and other data interfaces 626, and renders the browser intermediary user interface. User interface module 616 dynamically determines the size and position of each data representation to be displayed through the browser intermediary user interface. As described above, the size and position of each data representation may be based on any number of factors including, but not limited to, popularity and recentness of a post.

Browser interface 618 provides communication between the browser intermediary 612 and browser application 610. In addition to enabling the browser intermediary 612 to cause browser application 610 to be executed, browser interface 618 enables browser intermediary 612 to access data that includes, but is not limited to, a user's favorite web sites, a user's most recently visited web sites, and/or a user's most frequently visited web sites. In an example implementation, the data received through browser interface 618 is used to render the “Recent” section 110 of browser intermediary user interface 108.

Top stories interface 620 provides communication between client device 106 and one or more data sources through which popular web content is identified. For example, top stories interface 620 may be configured to access one or more news websites, one or more entertainment-news web sites, and any number of other popular websites to gather information about the top stories at any given time. In an example implementation, the sites that are accessed may be pre-defined and/or may be user-customizable. For example if a user is not interested in YouTube videos, then YouTube.com, which may be a pre-defined website to be monitored, may be de-selected by the user so that the “Top Stories” section 112 will not include top YouTube videos. Similarly, a user may select one or more websites to be monitored, even though those sites may not be part of the pre-defined group of websites to be monitored.

In an example implementation, the data received through top stories interface 620 indicates top stories from any number of websites, and an indication of relative popularity among the indicated top stories. As described above, the relative popularity may be used to dynamically determined size and or position of representations of the top stories in the browser intermediary user interface 108.

Social network interface 622 monitors social network posts made by individuals or entities (e.g., a friend or a musical group) that the user has chosen to follow, for example, by becoming a “friend” or “fan” through a social networking site like Facebook or Twitter. Posts by the individuals or entities being followed that include shared web content are pushed to mobile device 106, and used to dynamically generate the “What's New” section 114 of browser intermediary user interface 108.

RSS feed interface 624 monitors RSS feeds to which a user has subscribed. Based on the user subscription, data broadcast through the RSS feed is pushed to mobile device 106, and used to dynamically generate the “What's New” section 114 of browser intermediary user interface 108.

Although illustrated in FIG. 6 as being stored in memory 606 of mobile device 106, browser intermediary 612, or portions thereof, may be implemented using any form of computer-readable media that is accessible by mobile device 106. Furthermore, in alternate implementations, one or more components of operating system 608, browser application 610, browser intermediary 612, and/or other application 614 may be implemented as part of an integrated circuit that is part of, or accessible to, mobile device 106. Furthermore, although illustrated and described as being implemented on a mobile device 106, the data access and other functionality provided by browser intermediary 612 as described herein may also be implemented on any other type of computing device through which a user can access data, including, but not limited to, desktop computer systems and laptop computer systems.

Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

### Example Operation

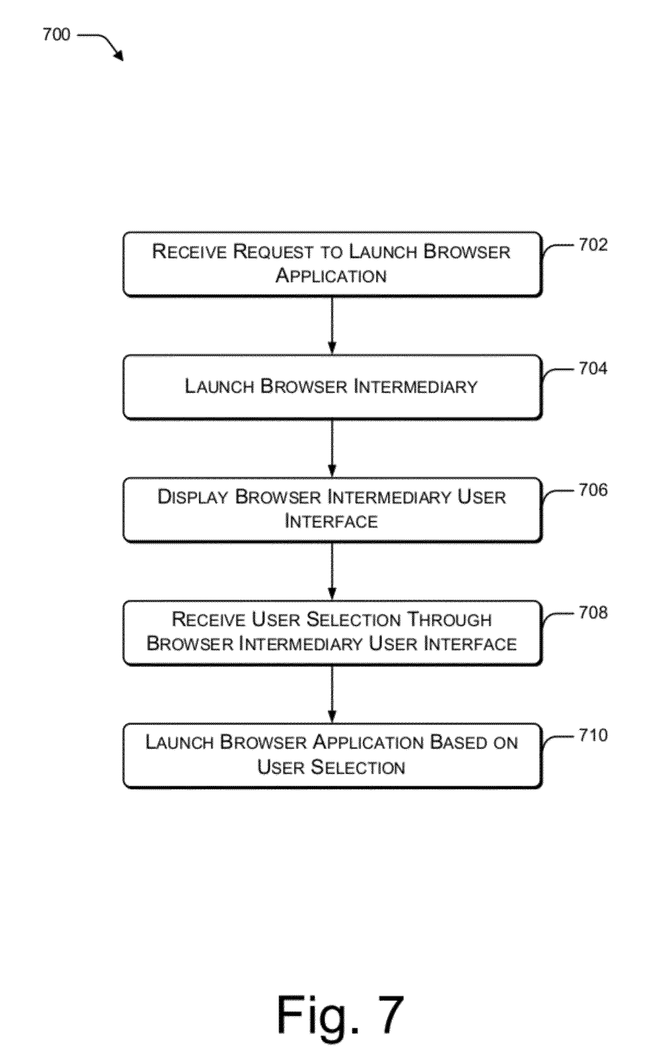

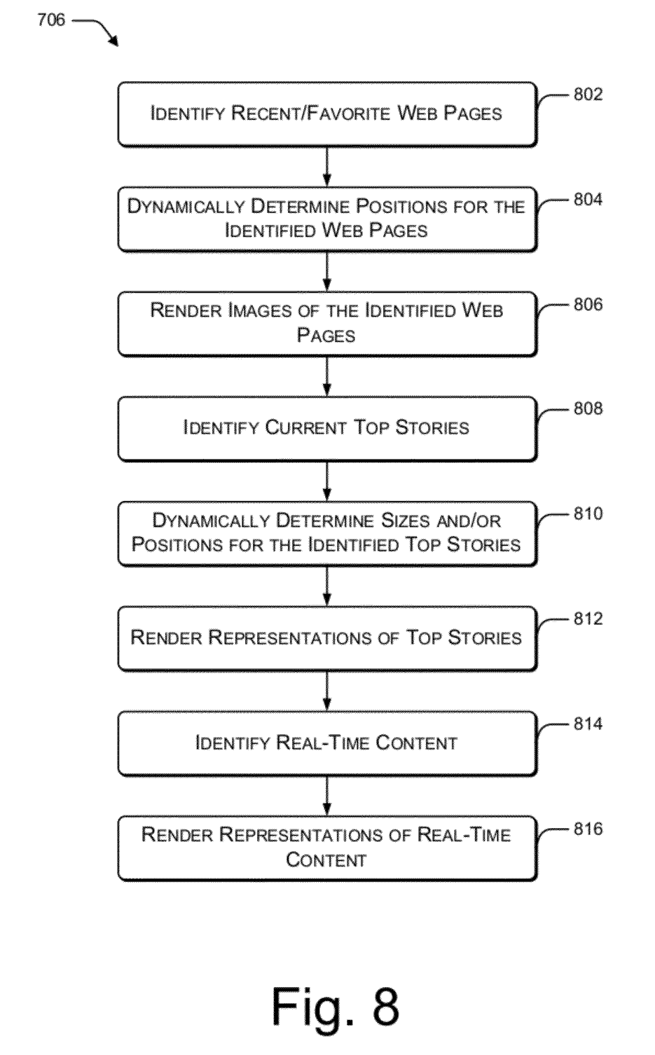

FIGS. 7 and 8 illustrate an example process 700 for implementing a browser intermediary as described herein. This process is illustrated as a collection of blocks in a logical flow graph, which represents a sequence of operations that can be implemented in hardware, software, or a combination thereof. In the context of software, the blocks represent computer-executable instructions stored on one or more computer storage media that, when executed by one or more processors, cause the processors to perform the recited operations. Note that the order in which the process is described is not intended to be construed as a limitation, and any number of the described process blocks can be combined in any order to implement the process, or alternate processes. Additionally, individual blocks may be deleted from the processes without departing from the spirit and scope of the subject matter described herein. Furthermore, while this process is described with reference to the mobile device 106 described above with reference to FIG. 1 and FIG. 6, other computer architectures may implement one or more portions of this process, in whole or in part.

FIG. 7 illustrates an example process 700 for implementing a browser intermediary.

At block 702, a request to launch a browser application is received. For example, as illustrated in FIG. 2, a user may select a browser application (e.g., Internet Explorer 204) from a main page provided by a mobile device operating system.

At block 704, instead of launching the selected browser application, a browser intermediary is launched. In an example implementation, the mobile device 106 may come pre-loaded with a default browser application. The mobile device 106 may be configured to launch the browser intermediary when the browser application is selected. In an alternate implementation, a user may opt-in through customizable device settings to have the browser intermediary launched when any of a number of specific browser applications is selected. For example, if the mobile device 106 is loaded with multiple browser applications, the user may be able to customize the device to launch the browser intermediary when particular browser applications are selected, and to directly launch the browser (bypassing the browser intermediary) when other browser applications are selected.

At block 706, the browser intermediary user interface is displayed. For example, when the user selects the browser application 610, and the browser intermediary 612 is launched, the user interface module 616 generates and displays browser intermediary user interface 108. As discussed in further detail below with reference to FIG. 8, other components of browser intermediary 612 are used to populate the user interface 108 with up-to-date information.

At block 708, a user selection is received through the browser intermediary user interface. For example, as illustrated in FIGS. 3-5, a user may select a recent web page, a top story, or a representation of real-time data, each displayed through browser intermediary user interface 108.

At block 710, in response to receiving the user selection through the browser intermediary user interface, the previously selected browser application is launched. For example, as illustrated in FIG. 3, the browser application is launched and the msn.com web page is loaded based on user selection of the representation of MSN in the browser intermediary user interface. As another example, as illustrated in FIG. 4, the browser application is launched and a web page presenting a top news story is loaded based on user selection of the representation of the top news story in the browser intermediary user interface. As a third example, as illustrated in FIG. 5, the browser application is launched and a web page associated with web content shared through a social networking site is loaded based on user selection of a recent social networking post displayed in the browser intermediary user interface.

FIG. 8 illustrates an example process 706 for presenting data in a browser intermediary user interface.

At block 802, recent and/or favorite web pages are identified. For example, browser interface 618 accesses history data and/or user-specified favorites data associated with browser application 610.

At block 804, positions for the identified web pages are dynamically determined. For example, user interface module 616 determines where representations of each recent/favorite web page will appear. Positions may be determined based on any number of factors including, but not limited to, relative frequency with which the user visits the web pages, relative durations since the user last visited each of the web pages, relative durations since individual ones of the identified web pages were identified as a user favorite, and so on.

At block 806, images of the identified web pages are rendered for display. For example, user interface module 616 generates a user interface display 108 that includes representations of the identified recent/favorite web pages in a “Recent” section 110.

At block 808, current top stories are identified. For example, top stories interface 620 accesses various web sites to determine stories that are currently popular, and to determine relative popularities of the stories.

At block 810, display sizes and positions for the identified top stores are dynamically determined. For example, user interface module 616 determines where representations of each top story will appear, as well as relative sizes of the representations to be displayed. Sizes and positions may be determined based on any number of factors including, but not limited to, relative popularities of the various stories that are determined.

At block 812, representations of the identified top stories are rendered for display. For example, user interface module 616 generates a user interface display 108 that includes representations of the identified top stories in a “Top Stories” section 112.

At block 814, real-time content is identified. For example, social network interface 622 and RSS feed interface 624 monitor previously identified social networking contacts associated with the user and RSS feeds to which the user subscribes. Recent posts are identified and provided to user interface module 616.

At block 816, representations of the identified real-time content are rendered for display. For example, user interface module 616 generates a user interface display 108 that includes representations of the real-time data in a “What's New” section 114.

### CONCLUSION

Although the subject matter has been described in language specific to structural features and/or methodological operations, it is to be understood that the subject matter defined in the appended claims is not necessarily limited to the specific features or operations described. Rather, the specific features and acts are disclosed as example forms of implementing the claims.

What is claimed is:

1. A method comprising:
receiving a user-submitted command to launch a browser application; and
in response to receiving the user-submitted command, launching a browser intermediary instead of launching the browser application, the browser intermediary presenting a user interface that displays selectable representations of multiple web pages.

2. A method as recited in claim 1, wherein the selectable representations of multiple web pages include representations of one or more user-specified favorite web pages.

3. A method as recited in claim 1, wherein the selectable representations of multiple web pages include representations of one or more recently viewed web pages.

4. A method as recited in claim 1, wherein the selectable representations of multiple web pages include representations of one or more frequently viewed web pages.

5. A method as recited in claim 1, wherein the selectable representations of multiple web pages include representations of web pages that are currently popular.

6. A method as recited in claim 1, wherein the selectable representations of multiple web pages include representations of web pages associated with top news stories.

7. A method as recited in claim 1, wherein the selectable representations of multiple web pages include representations of web content shared through recent social networking updates.

8. A method as recited in claim 1, wherein the selectable representations of multiple web pages include representations of recent Really Simple Syndication (RSS) feeds.

9. A method as recited in claim 1, further comprising:
receiving a user-submitted selection through the browser intermediary; and
in response to the user-submitted selection through the browser intermediary, launching the browser application.

10. A method as recited in claim 9, wherein launching the browser application includes loading a web page in a user interface associated with the browser application, the web page being associated with the user-submitted selection received through the browser intermediary.

11. One or more computer readable media encoded with computer-executable instructions that, when executed, configure a computer system to perform a method as recited in claim 1.

12. A mobile computing device comprising:
a processor;
a memory communicatively coupled to the processor;
a browser application, at least partially stored in the memory and executable on the processor, to provide access to the World Wide Web; and
a browser intermediary, at least partially stored in the memory and executable on the processor, the browser intermediary configured to execute when the browser application is selected by a user for execution, thereby delaying execution of the browser application, the browser intermediary including:
a user interface module for rendering a user interface that includes any combination of:
representations of user-specified favorite web pages;
representations of recently viewed web pages;
representations of frequently viewed web pages;
representations of currently popular web content;
representations of recent real-time data;
a browser interface for identifying the user-specified favorite web pages, the recently viewed web pages, and the frequently viewed web pages;
a top stories interface for identifying the currently popular web content; and
a social network interface for identifying at least a portion of the recent real-time data.

13. A mobile computing device as recited in claim 12, the browser intermediary further including an Really Simple Syndication (RSS) feed interface for identifying at least a portion of the recent real-time data.

14. One or more computer readable media encoded with instructions that, when executed, direct a computing device to perform operations comprising:
displaying a browser intermediary user interface that includes selectable representations of a plurality of web-based content;
receiving a user-submitted selection of a representation of a particular web-based content; and
in response to receiving the user-submitted selection, launching a browser application and loading a web page associated with the web-based content into a user interface associated with the browser application.

15. One or more computer readable media as recited in claim 14, wherein the browser intermediary user interface includes a section for displaying representations of user-specified favorite web pages.

16. One or more computer readable media as recited in claim 14, wherein the browser intermediary user interface includes a section for displaying representations of currently popular web-based content.

17. One or more computer readable media as recited in claim 14, wherein the browser intermediary user interface includes a section for displaying representations of real-time data updates.

18. One or more computer readable media as recited in claim 17, wherein the real-time data updates include a social network post.

19. One or more computer readable media as recited in claim 17, wherein the real-time data updates include a really simple syndication (RSS) feed post.

20. One or more computer readable media as recited in claim 17, wherein the real-time data updates are associated with entities with which a user of the computing device has an established relationship.
